(19) United States
(12) Patent Application Publication
(10) Pub. No.: US 2011/0037649 A1
(43) Pub. Date: Feb. 17, 2011

(54) ENHANCING POSITION ACCURACY IN GLOBAL POSITIONING SYSTEM RECEIVERS

(75) Inventor: Sandeep RAO, Bangalore (IN)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/573,890

(22) Filed: Oct. 6, 2009

(30) Foreign Application Priority Data
Aug. 11, 2009 (IN) 1907/CHE/2009

(51) Int. Cl. G01S 19/21; G01S 19/34

(52) U.S. Cl. 342/357.59; 342/357.74

(57) ABSTRACT

Enhancing position accuracy in global positioning system receivers. A pseudorange is measured, in a receiver, from each signal of a plurality of signals. Each signal is received from a different one of a plurality of satellites. A check is performed for an inconsistency among measured pseudoranges. Each measured pseudorange corresponds to the different one of the plurality of satellites. Further a power saving mode of the receiver is inactivated if the inconsistency is determined among the measured pseudoranges. Additionally, a position of the receiver is determined when the power saving mode is inactivated.

### REFERENCE TO PRIORITY APPLICATION

This application claims priority from Indian Non-provisional Application Serial No. 1907/CHE/2009 filed Aug. 11, 2009, entitled “ENHANCING POSITION ACCURACY IN GLOBAL POSITIONING SYSTEM RECEIVERS”, which is incorporated herein by reference in its entirety.

### TECHNICAL FIELD

Embodiments of the disclosure relate to enhancing position accuracy in global positioning system (GPS) receivers.

### BACKGROUND

A technique to save power in a global positioning system (GPS) receiver, especially battery-powered GPS receiver, is to operate in a power save mode (PSM). In PSM the GPS receiver can be inactivated for a certain duration once every N seconds. The PSM saves power while providing accuracy in position in open-sky and suburban environments. However, in other environments such as urban canyons, formed by streets at ground level surrounded on two or more sides by tall buildings, the PSM can result in degradation of position accuracy. The degradation can occur due to the tall buildings that introduce multipath and other errors, and often completely block reception from satellites in some geometric regions of the sky. A GPS receiver that is continuously active can compensate for such errors better than another GPS receiver that is inactive for a part of every second. Hence, there is a need for the GPS receiver to dynamically inactivate the PSM whenever the GPS receiver is in an urban canyon.

Current solutions to inactivate the PSM are based on satellite carrier to noise ratio (C/No) and satellite geometry. However, the solutions have not led to reliable inactivation of the PSM in the urban canyons as the C/No of a satellite is not indicative of the multipath.

### SUMMARY

An example of a method includes measuring a parameter, in a receiver, from each signal of a plurality of signals. Each signal is received from a different one of a plurality of satellites. The method also includes checking for an inconsistency among measured parameters. Each measured parameter corresponds to the different one of the plurality of satellites. The method further includes inactivating a power saving mode of the receiver if the inconsistency is determined among the measured parameters. Moreover, the method includes determining a position of the receiver when the power saving mode is inactivated.

An example of an article of manufacture includes a machine readable medium. The machine-readable medium carries instructions operable to cause a programmable processor to perform measuring a pseudorange, in a global positioning system receiver, from each signal of a plurality of signals. Each signal is received from a different one of a plurality of satellites. The machine-readable medium also carries instructions operable to cause a programmable processor to perform checking for an inconsistency among measured pseudoranges. Each measured pseudorange corresponds to the different one of the plurality of satellites. The machine-readable medium further carries instructions operable to cause a programmable processor to perform inactivating a power saving mode of the receiver if the inconsistency is determined among the measured pseudoranges. Moreover, the machine-readable medium carries instructions operable to cause a programmable processor to perform determining a position of the receiver when the power saving mode is inactivated.

An example of a global positioning system receiver includes a radio frequency receiver that receives signals from a plurality of satellites. The global positioning system receiver also includes a memory that stores instructions. The global positioning system receiver further includes a measurement engine responsive to the instructions to measure a parameter, in the global positioning system receiver, from each signal of a plurality of signals. Each signal is received from a different one of the plurality of satellites. Moreover, the global positioning system receiver includes a position engine responsive to the instructions and measured parameters corresponding to the plurality of satellites to check for an inconsistency among the measured parameters, to inactivate a power saving mode of the global positioning system receiver if the inconsistency is determined among the measured parameters, and to determine at least one of a position and a velocity of the global positioning system receiver when the power saving mode is inactivated. Each measured parameter corresponds to the different one of the plurality of satellites.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the disclosure.

FIG. 1 illustrates an environment, in accordance with one embodiment;

FIG. 2 illustrates a block diagram of a global positioning system receiver, in accordance with one embodiment; and

FIG. 3 is a flow diagram illustrating a method for enhancing position accuracy in a receiver, in accordance with one embodiment.

### DETAILED DESCRIPTION OF THE EMBODIMENTS

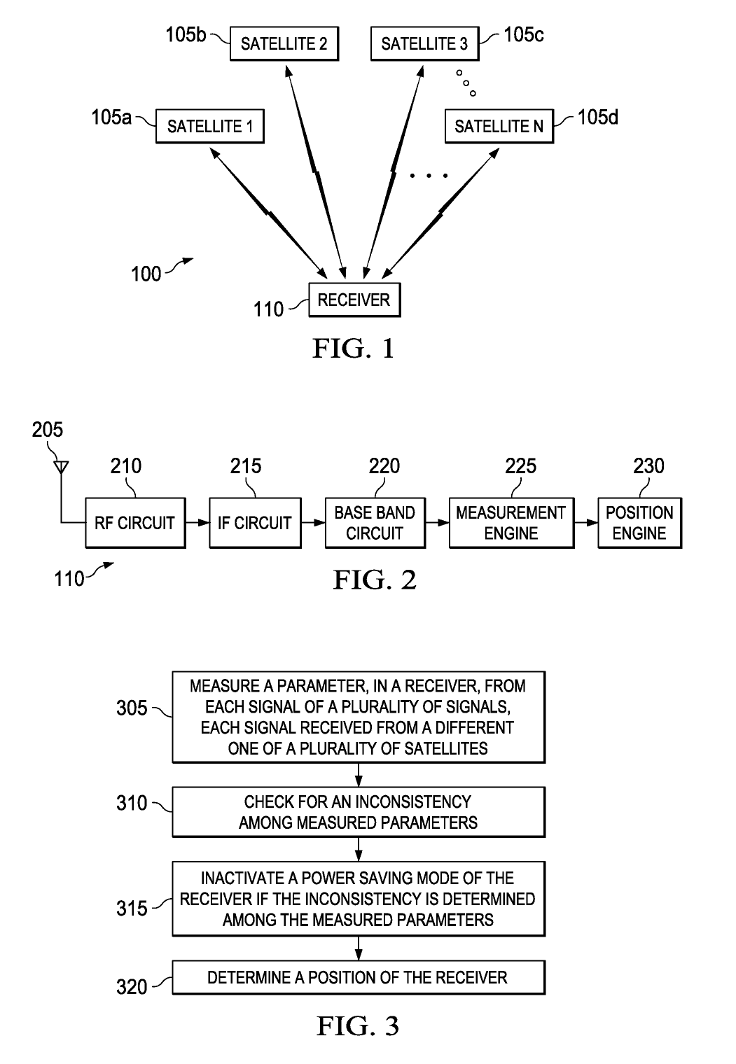

FIG. 1 illustrates an environment 100 including multiple satellites, for example a satellite 105a, a satellite 105b, a satellite 105c and a satellite 105d. The satellites are space vehicles and can be, for example global positioning system (GPS) satellites or other navigation satellites. The environment 100 also includes a receiver 110, for example a GPS receiver or any other satellite navigation receiver. The GPS receiver can be a type of satellite navigation receiver and can also be referred to as the satellite navigation receiver. The receiver 110 is used to provide navigational data to a user. The receiver 110 can be included in different devices. Examples of the devices include, but are not limited to, personal navigation devices, computers, laptops, palmtops, mobiles, personal digital assistants, data processing units, and computing devices.

A signal is received by a receiver 110 from each satellite. In one embodiment, signals are received from the satellites. The receiver 110 then determines position of the receiver 110 from the signals. Each signal includes information about time at which the signal was transmitted, orbital information of the satellite that sends the signal, and general information of various satellites. Distance of the receiver 110 from the satellite can be determined based on the information present in the signal. A pseudorange can be defined as a measured distance between a satellite and the receiver 110. The pseudorange can be measured by estimating the time of travel of the signal from the satellite to the receiver 110. The pseudorange measured from the satellite, for example the satellite 105a can be referred to as the pseudorange corresponding to the satellite 105a. A velocity of the receiver 110 can also be determined using Doppler frequency. The Doppler frequency can be defined as the difference between a nominal satellite transmission frequency and a frequency which is measured at the receiver 110. The Doppler frequency measured from a satellite, for example the satellite 105a can be referred to as the Doppler frequency corresponding to the satellite 105a.

The receiver 110 receives the signals that have different frequencies corresponding to different satellites. The signals can be received when the user is in different areas, for example rural, suburban and urban areas. The position and the velocity determined from the pseudorange and the Doppler frequency, respectively, may not be accurate when the receiver 110 is in urban canyons, formed by streets at ground level surrounded on two or more sides by tall buildings. The receiver 110 for determining accurate position and velocity is explained in conjunction with FIG. 2.

Referring now to FIG. 2, a satellite navigation receiver or a GPS receiver, for example a receiver 110 is illustrated. An antenna 205 is included in or connected to the receiver 110 to transmit and receive signals. The receiver 110 includes a radio frequency (RF) circuit 210, an intermediate frequency (IF) circuit 215, a baseband circuit 220, a measurement engine 225, and a position engine 230. The receiver 110 can include an RF receiver that receives signals from multiple satellites via the antenna 205. The RF receiver can be included in the RF circuit 210. The RF circuit 210 removes unwanted input frequencies from a signal and amplifies the signal using filters and a low noise amplifier respectively. The intermediate frequency (IF) circuit 215 performs IF processing to convert the signal to an IF signal. The IF circuit 215 converts the signal to an IF using a reference signal, filters unwanted harmonics and amplifies a resulting IF signal using a combination of a mixer, a local oscillator, an IF filter and an IF amplifier. The IF signal is then down converted to a baseband signal.

The baseband circuit 220 performs baseband processing. The baseband circuit 220 performs correlation of the baseband signal and processes the baseband signal using a combination of components, for example demodulators, a local oscillator, baseband filters and baseband amplifiers. Further, the baseband circuit 220 identifies a correlation peak of the signal. The correlation peak helps in estimating accurate position of the receiver 110 when the receiver 110 has a direct line of sight signal from the satellite as is in rural or suburban areas. However, when the receiver 110 is in an urban canyon then it is desired to measure samples around the correlation peak and also the correlation peak. The samples around the correlation peak can help in identifying the extent of multipath and can improve accuracy of position of the receiver 110 as compared to the position determined without use of the samples. The correlation peak and shape of the signal around the peak indicated by the samples can be processed further by various algorithms. The samples can correspond to a predefined range. The shape of the signal can be determined by the baseband circuit 220 with high accuracy when a power saving mode (PSM) is inactivated. The PSM can be defined as a mode in which the receiver 110 is inactive for a certain duration once every N seconds.

The measurement engine 225 measures a parameter, for example a pseudorange or a Doppler frequency, from a signal received from a satellite. In one embodiment, the parameters are measured from the signals received from the satellites. The parameters can be referred to as measured parameters. The position engine 230 checks for an inconsistency among the measured parameters and inactivates the PSM of the receiver 110 if the inconsistency is determined. The position engine 230 further determines a position of the receiver 110. The velocity of the receiver 110 can also be determined.

In some embodiments, the measurement engine 225 and the position engine 230 can also be included in a processing unit. The processing unit can perform functions of the measurement engine 225 and the position engine 230.

In some embodiments, the position and velocity of the receiver 110 can be displayed. Further, latitude and longitude, elevation information can also be displayed. The receiver 110 can also display derived information, for example direction.

Each circuit and engine can operate in response to instructions stored in a memory or a machine-readable medium. Examples of the machine-readable medium include, but are not limited to, magnetic disks, optical disks and other electrical or magnetic storage medium.

FIG. 3 is a flow diagram illustrating a method for enhancing position accuracy in a receiver.

At step 305, a parameter is measured, in the receiver, from each signal of multiple signals. Each signal is received from a different one of the satellites. Each satellite transmits a signal that includes time at which the signal was transmitted, orbital information of the satellite that transmits the signal, and general information of the satellites.

In some embodiments, the satellites for which the parameters are measured can be selected. The selection can be based on one or more factors, for example visibility of the satellite, strength of the signal and satellite geometry. In some embodiments, the parameter can be a pseudorange. In some embodiments, the parameter can be a Doppler frequency at which the signal is transmitted. The parameter measured from each signal can be referred to as a measured parameter.

An inconsistency is checked among measured parameters at step 310. Each measured parameter corresponds to the different one of the satellites. In some regions, for example urban canyons, problem of multipath might occur. The multipath may lead to an error in measurement of the parameters. The error results in the inconsistency among the measured parameters.

In one embodiment, the inconsistency is checked based on the pseudoranges. An estimated position of the receiver is determined from measured pseudoranges. For example, the receiver measures pseudoranges P₁, P₂, . . . P_{N} from satellite 1, satellite 2, . . . satellite N. In one example, P₁ represents a pseudorange measured from I^{th} satellite, where I=1, 2, . . . N refers to N visible satellites at a given point of time. The pseudoranges are then used to determine the estimated position and a clock bias of the receiver. The estimated position of the receiver and a clock bias is determined using one or more techniques, for example Weighted Least Square solution and a Kalman Filter based solution. The estimated position can be represented by coordinates, for example (X_{RX}, Y_{RX}, Z_{RX}) and the clock bias by C_{RXBIAS}. The distance between the estimated position of the receiver (X_{RX}, Y_{RX}, Z_{RX}) and a position of each satellite is computed. The position of each satellite is determined and the position of I^{th} satellite can be represented by coordinates, for example (X_{SI}, Y_{SI}, Z_{SI}). In one example, the distance between the estimated position of the receiver and the position of each satellite, in meters, is computed using equation (1).

\sqrt{(X_{SI}−X_{RX})²+(Y_{SI}−Y_{RX})²+(Z_{SI}−Z_{RX})²} (1)

In addition, the measured pseudorange for each satellite can be corrected for errors, for example the clock bias (C_{RXBIAS}), a satellite clock bias (C_{SATI}_{_{—}}_{BIAS}), a tropospheric error (E_{TROPO}) and an ionospheric error (E_{IONO}). The pseudorange (P_{ICORRECTED}) can then be corrected using equation (2).

P_{ICORRECTED}=P_{I}−C_{RXBIAS}−C_{SATBIAS}−E_{IONO}−E_{TROPO} (2)

A difference between the pseudorange and the distance corresponding to each satellite is then determined. In one example, the difference, in meters, is determined using equation (3).

P_{ICORRECTED}=\sqrt{(X_{SI}−X_{RX})²+(Y_{SI}−Y_{RX})²+(Z_{SI}−Z_{RX})²} (3)

An error is obtained based on the difference determined from equation (3). The error is a measure of the inconsistency between the pseudoranges and the estimated position of the receiver. In one example, the error is determined using equation (4).

E_{I}=measured distance to I^{th} satellite−computed distance to I^{th} satellite

E_{I}=P_{ICORRECTED}−\sqrt{(X_{SI}−X_{RX})²+(Y_{SI}−Y_{RX})²+(Z_{SI}−Z_{RX})²} (4)

The error E_{I} can be used to define an error metric (M). If the error metric exceeds a threshold, presence of the inconsistency among the pseudoranges is determined and step 315 is then performed.

A degree of the inconsistency can be defined using the error metric. In one example, the metric is defined using equation (5).

$$M = {\sum }_{I = 1}^{I = N} {( {E}_{I} )}^{2} \qquad ( 5 )$$

In another example, summation in equation (5) can be modified to include satellites that are used for obtaining the estimated position of the receiver.

In some embodiments, the error metric can be averaged or filtered across a predefined time interval, and checked against a threshold. If the error metric exceeds the threshold then step 315 can be performed.

In another embodiment, the inconsistency is checked based on Doppler frequencies. An estimated velocity of the receiver is determined from the Doppler frequencies corresponding to the satellites. For example, the receiver measures Doppler frequencies F₁, F₂, . . . F_{N} of satellite 1, satellite 2, . . . satellite N. In one example, F₁ represents a Doppler frequency measured from I^{th} satellite, where I=1, 2, . . . N refers to N visible satellites at a given point of time. The estimated velocity can be represented by coordinates, for example (VX_{RX}, VY_{RX}, VZ_{RX}). The velocity of the satellite N in meter/sec can be represented by coordinates, for example (VX_{SN}, VY_{SN}, VZ_{SN}). An estimated frequency is determined corresponding to the different one of the satellites e based on the estimated position and the estimated velocity of the receiver, and a position and a velocity of each satellite. In one example, the estimated frequency can be determined using equation (6).

$$\frac{( {X}_{SI} - {X}_{RX} ) ( {VX}_{SI} - {VX}_{RX} )}{\sqrt{{( {X}_{SI} - {X}_{RX} )}^{2} + {( {Y}_{SI} - {Y}_{RX} )}^{2} + {( {Z}_{SI} - {Z}_{RX} )}^{2}}} + … \\ \frac{( {Y}_{SI} - {Y}_{RX} ) ( {VY}_{SI} - {VY}_{RX} )}{\sqrt{{( {X}_{SI} - {X}_{RX} )}^{2} + {( {Y}_{SI} - {Y}_{RX} )}^{2} + {( {Z}_{SI} - {Z}_{RX} )}^{2}}} + … \\ \frac{( {Z}_{SI} - {Z}_{RX} ) ( {VZ}_{SI} - {VZ}_{RX} )}{\sqrt{{( {X}_{SI} - {X}_{RX} )}^{2} + {( {Y}_{SI} - {Y}_{RX} )}^{2} + {( {Z}_{SI} - {Z}_{RX} )}^{2}}} \qquad ( 6 )$$

In addition, the measured Doppler frequency for each satellite can be corrected for errors, for example a clock drift (C_{RXDRIFT}) of the receiver and a satellite clock drift (C_{SATIDRIFT}). The Doppler frequency (F_{ICORRECTED}) can be corrected using equation (7).

F_{ICORRECTED}=F_{I}−C_{RXDRIFT}−C_{SATIDRIFT} (7)

An error metric is then obtained based on estimated frequencies and measured Doppler frequencies corresponding to the satellites. Further, presence of the inconsistency is determined if the error metric exceeds a certain threshold.

At step 315, a PSM of the receiver is inactivated if the inconsistency is determined among the measured parameters. The inconsistency indicates that the receiver has entered into a particular terrain, for example an urban canyon, and the PSM is then inactivated to help prevent further deterioration of position accuracy in the receiver.

The position of the receiver is determined when the power saving mode is inactivated at step 320. Velocity of the receiver can also be determined. The position and the velocity determined when the PSM is inactive is accurate as compared to the estimated position and the estimated velocity which are determined when the PSM is active, in the urban canyon. Different techniques can be used to determine the position and velocity of the receiver, for example Weighted Least Square solution or a Kalman Filter based solution. When the receiver is in the urban canyon then it is desired to measure samples around a correlation peak of signals received from the satellites. The samples around the correlation peak can help in identifying the extent of multipath and can improve accuracy of position determination in the receiver as compared to the position determined without use of the samples. The correlation peak and shape of the signal around the peak indicated by the samples can be processed further by various algorithms to determine the position. The samples can correspond to a predefined range. The shape of the signal can be determined accurately when the PSM is inactive.

The foregoing description sets forth numerous specific details to convey a thorough understanding of embodiments of the disclosure. However, it will be apparent to one skilled in the art that embodiments of the disclosure may be practiced without these specific details. Some well-known features are not described in detail in order to avoid obscuring the disclosure. Other variations and embodiments are possible in light of above teachings, and it is thus intended that the scope of disclosure not be limited by this Detailed Description, but only by the Claims.

What is claimed is:

1. A method comprising:
measuring a parameter, in a receiver, from each signal of a plurality of signals, each signal received from a different one of a plurality of satellites;
checking for an inconsistency among measured parameters, each measured parameter corresponding to the different one of the plurality of satellites;
inactivating a power saving mode of the receiver if the inconsistency is determined among the measured parameters; and
determining a position of the receiver when the power saving mode is inactivated.

2. The method as claimed in claim 1 and further comprising:
determining a velocity of the receiver when the power saving mode is inactivated.

3. The method as claimed in claim 1, wherein measuring the parameter comprises:
measuring a pseudorange.

4. The method as claimed in claim 3, wherein checking for the inconsistency comprises:
determining an estimated position of the receiver and a clock bias of the receiver from pseudoranges, each pseudorange corresponding to the different one of the plurality of satellites;
computing a distance between the estimated position of the receiver and a position of each satellite;
determining, for each satellite, a difference between the pseudorange and the distance corresponding to that satellite;
obtaining an error metric based on determined differences; and
determining presence of the inconsistency if the error metric exceeds a threshold.

5. The method as claimed in claim 4, wherein determining the estimated position comprises:
correcting each pseudorange based on at least one of
the clock bias of the receiver,
a satellite clock bias,
a tropospheric error, and
an ionospheric error.

6. The method as claimed in claim 3, wherein measuring the parameter further comprises:
measuring a Doppler frequency.

7. The method as claimed in claim 6, wherein checking for inconsistency comprises:
determining an estimated velocity of the receiver from Doppler frequencies, each Doppler frequency corresponding to the different one of the plurality of satellites;
determining an estimated position of the receiver from pseudoranges;
determining an estimated frequency corresponding to the different one of the plurality of satellites based on the estimated position and the estimated velocity of the receiver, and a position and a velocity of each satellite of the plurality of satellites;
obtaining an error metric based on estimated frequencies corresponding to the plurality of satellites and measured Doppler frequencies corresponding to the plurality of satellites; and
determining presence of the inconsistency if the error metric exceeds a threshold.

8. The method as claimed in claim 7, wherein determining the estimated velocity comprises:
correcting each Doppler frequency corresponding to the different one of the plurality of satellites based on at least one of
a clock drift of the receiver, and
a satellite clock drift.

9. The method as claimed in claim 1, wherein the receiver is at least one of:
a global positioning system receiver; and
a satellite navigation receiver.

10. An article of manufacture comprising:
a machine readable medium; and
instructions carried by the machine-readable medium and operable to cause a programmable processor to perform:
measuring a pseudorange, in a global positioning system receiver, from each signal of a plurality of signals, each signal received from a different one of a plurality of satellites;
checking for an inconsistency among measured pseudoranges, each measured pseudorange corresponding to the different one of the plurality of satellites;
inactivating a power saving mode of the receiver if the inconsistency is determined among the measured pseudoranges; and
determining a position of the receiver when the power saving mode is inactivated.

11. The article of manufacture as claimed in claim 10 further comprising instructions operable to cause the programmable processor to perform:
determining a velocity of the receiver when the power saving mode is inactivated.

12. The article of manufacture as claimed in claim 11, wherein checking for the inconsistency comprises:
determining an estimated position of the receiver and a clock bias of the receiver from pseudoranges;
computing a distance between the estimated position of the receiver and a position of each satellite;
determining, for each satellite, a difference between the pseudorange and the distance corresponding to that satellite;
obtaining an error metric based on determined differences; and
determining presence of the inconsistency if the error metric exceeds a threshold.

13. The article of manufacture as claimed in claim 12, wherein determining the estimated position comprises:
correcting each pseudorange based on at least one of
the clock bias of the receiver,
a satellite clock bias,
a tropospheric error, and
an ionospheric error.

14. The article of manufacture as claimed in claim 11 and further comprising:
measuring a Doppler frequency.

15. The article of manufacture as claimed in claim 14 and further comprising:
determining an estimated velocity of the receiver from Doppler frequencies, each Doppler frequency corresponding to the different one of the plurality of satellites;
determining an estimated position of the receiver from pseudoranges;
determining an estimated frequency corresponding to the different one of the plurality of satellites based on the estimated position and the estimated velocity of the receiver, and a position and a velocity of each satellite of the plurality of satellites;
obtaining an error metric based on estimated frequencies corresponding to the plurality of satellites and measured Doppler frequencies corresponding to the plurality of satellites; and
determining presence of the inconsistency if the error metric exceeds a threshold.

16. The article of manufacture as claimed in claim 15, wherein determining the estimated velocity comprises:
correcting each Doppler frequency based on at least one of
a clock drift of the receiver, and
a satellite clock drift.

17. A global positioning system receiver comprising:
a radio frequency receiver that receives signals from a plurality of satellites;
a memory that stores instructions;
a measurement engine responsive to the instructions to measure a parameter, in the global positioning system receiver, from each signal of a plurality of signals, each signal received from a different one of the plurality of satellites;
a position engine responsive to the instructions and measured parameters corresponding to the plurality of satellites, each measured parameter corresponding to the different one of the plurality of satellites, to
check for an inconsistency among the measured parameters;
inactivate a power saving mode of the global positioning system receiver if the inconsistency is determined among the measured parameters; and
determine at least one of a position and a velocity of the global positioning system receiver when the power saving mode is inactivated.
